(19) United States
(12) Patent Application Publication
(10) Pub. No.: US 2006/0201902 A1
(43) Pub. Date: Sep. 14, 2006

(54) Fully continuously vented drinking cup for infants and children

(76) Inventors: Craig E. Brown, Mount Zion, IL (US); Robert J. Brown, Chesterfield, MO (US)

Correspondence Address: Paul M. Denk, Ste. 170, 763 S. New Ballas Road, St. Louis, MO, 63141, US

(21) Appl. No.: 11/359,157

(22) Filed: Feb. 21, 2006

Related U.S. Application Data
(60) Provisional application No. 60/658,129, filed on Mar. 3, 2005.

(51) Int. Cl. A61J 9/00; B65D 45/00; A47G 19/22

(52) U.S. Cl. 215/11.4; 220/714; 215/276

(57) ABSTRACT

A fully and continuously vented drinking cup or container for infants and children, which consists of a vessel or container for containing a liquid or formula, having a resilient spout which rests upon its uppermost edge. The interior aspects of the feeding spout, and the feeding diaphragm, are all molded so as to arrange the diaphragm slit, or opening through which the liquid flows, in a position that will be vertically aligned between the lips of the infant feeding, to thereby allow the infant to open the spout and allow the liquid to flow, just as if the child is drinking from a cup. The diaphragm may be shaped concavely, with respect to the structure of the feeding spout. A cap firmly approximates the interior aspects of the feeding spout, and applies it to the top or upper edge of the container, whereby a leak proof seal is formed therebetween, but yet allows air to enter between its retaining collar, and the vent tube and reservoir tube, to allow air access into the container, as liquid is being drank therefrom.

### CROSS REFERENCE TO RELATED APPLICATION

This nonprovisional patent application claims priority to the related provisional patent application having Ser. No. 60/658,129 which was filed on Mar. 3, 2005 and claims priority to the nonprovisional patent application having Ser. No. 10/283,878, which was filed on Oct. 10, 2002.

### BACKGROUND OF THE INVENTION

This invention relates to delivery of liquids to an infant or child, and more specifically pertains to a fully and continuously vented drinking cup for the infant and child.

As is well known from antiquity, babies are born with the instinct to breastfeed, but it is often necessary for them to be fed from man-made containers, such as the well known baby bottle. This is necessary in order to insure hydration and an adequate supply of caloric intake. A nursing bottle includes the concept of utilizing the length of bottle, with a nipple located at its upper end, the latter being made of one of a variety of materials, and having a small hole provided therein, through which the liquid may be dispensed. The nipple is customarily held in place by a collar, which fastens it firmly onto the upper end of the bottle, the latter which contains the liquid to be fed. The bottle is filled with a liquid, whether it be milk, the formula, water, juices, or any other type of liquids, and then the nipple is applied, the collar is secured tightly in place upon he bottle, and when the baby sucks on the nipple, with a negative pressure generated in the oral cavity, because of such sucking, the liquid is withdrawn from the bottle.

Originally, drinking cups for infants and children previously were simply a container to hold the liquid to be fed to the child. A lip at the spout for the child was attached to the top of the container. This made it difficult for the child to feed, because a significant amount of vacuum was formed within the container, particularly when the child is sucking, and that vacuum had to be overcome for each drink from the container, to get any liquid to discharge into the mouth. The Dahan, U.S. Pat. No. 4,568,621, discloses a feeding nipple that discharges liquid through the side of the nipple; however, there is no venting of the container holding the liquid at all. Therefore, the infant has to suck with very significant force in order to get any liquid from the feeding container. This is highly undesirable, for reasons which will be subsequentially defined.

After the introduction of the completely sealed container with the instant development of a negative pressure therein, and the difficulty of attempting to withdraw the feeding liquid from the container as air must enter the container in order to displace the vacuum which has formed, not only prevents the effective flow of liquid to be withdrawn from the container, but can have other detrimental effects upon the teeth. During usage of these early embodiments, a vacuum must form on the interior of the oral cavity and within the feeding container in order to open the valve, and hold the valve in its opened position, during liquid discharge. Also, of note, is that previous designs not only contained one or more valves, but also did not allow for relief of the vacuum from within the container during usage. This is because the introduction of the air, for relief of the vacuum, is into the liquid, and not into the free space, such as the free air contained in the back end of the feeding container.

Other attempts have been made to provide a nursing bottle with an air vent to enable ambient air to enter the container during usage. For example, the Roderick, U.S. Pat. No. 598,231, discloses a nursing bottle having a U-shaped air tube. One end of the tube communicates with the top of the container interior, while the other end communicates with the ambient air outside of the bottle. When the bottle is inverted, the liquid rises into the tube and then impedes the flow of air into the interior of the container. If the bottle is placed upright quickly, the liquid in the tube does not have a chance to drain and it remains in the tube. When the bottle is again inverted, the liquid spills out the end of the tube, which communicates with the ambient air, therefore significant leakage can occur. Other nursing bottles with air vents are disclosed in the Van Cleave U.S. Pat. No. 927,013, in addition to the patent to Davenport, U.S. Pat. No. 1,441,623. Furthermore, the Perry U.S. Pat. No. 2,061,477, shows a further nursing bottle with an air vent. None of these nursing bottles completely solve the problem of venting the interior of the bottle at atmospheric pressure, while preventing leaks and spills form the bottle, while it is inverted, and during drinking. Essentially, a demand still exists for a nursing bottle, one that can be used as a sippy type cup, and which helps train the infant or child to drink, rather than suck the liquid free, and to do so in a manner that prevents the formation of a partial vacuum within the bottle during nursing and drinking, but yet resist spills. The U.S. Pat. No. 6,745,915, to Rees, also shows a pair of apertures for feeding and draining of liquid, but does not allow for venting of the feeding vessel during performance of such activity. This container functions in the same fashion as the other containers of the prior art, just utilizing one venting structure.

As previously commented, there are several significant disadvantages to the excessive sucking that infants must do while using both the completely unvented arrangement, and the partial vented structure. This has been previously reviewed in our prior U.S. Pat. No. 5,779,071, in addition to U.S. Pat. No. 5,570,796.

Negative pressure must be applied to get any liquid out of the previous containers. The amount of negative pressure necessary to cause liquid to exit the bottle increases as the infant continues to drink from the container. Thus, the more liquid that is extracted with a vacuum and negative pressure that is generated within the bottle, the more sucking can be detrimental to the infant.

Also, pressure is the opposite type of pressure that is encountered when an infant is breastfeeding, or when an individual utilizes a standard drinking cup that is open, and not sealed, and therefore, does not generate any type of vacuum. Thirdly, it is known that negative pressure that is applied in order to obtain liquid to flow from an infant bottle or cup, has a tendency to travel up the eustachian tubes of the individual, and into the middle ears of the infant. Negative pressure is known to cause fluid build-up in the middle cavity of the ears. This fluid is associated with decrease in hearing, as well as motor and intellectual functional delays. As the infant continues to increase the sucking pressure necessary to overcome the increasing negative pressure that is building up in the bottle, air enters the mouth, esophagus, the stomach, and eventually the colon, all of which has been linked to irritability, and also colic, a condition characterized by abdominal discomfort and pain. This is also noted in previous publications, such as the authored works by O. P. Matthew, entitled The Science of Bottle Feeding, the Journal of Pediatrics, October 1991, page 511, in addition to the publication of W. R. Treem, entitled Infant Colic, Pediatric Clinics of North America, October 1994, page 1121.

A negative pressure also forms in the intraoral cavity when an infant sucks on a pacifier or their thumb. It has been noted that these events, along with the associated negative pressure formation in the intraoral cavity, can cause the generation of ear fluid, decrease hearing, and in extreme cases, may result in developmental delays, as well as other abnormalities that were outlined.

The pressure that is encountered is the opposite of the pressure that is experienced during breastfeeding. The pressure that is encountered with breastfeeding is a positive pressure. This is easily observed when breast milk spontaneously leaves the breast, even after the infant has finished breastfeeding. This continues for a period of time, during which time women typically wear some form of a breast pad. The positive pressure that is present with breastfeeding allows the infant to feed on demand, which is the preferred method of infant feeding. Hence, from a physiological standpoint, breastfeeding, as an act between the mother and infant, already compensates for problems that are inherent when an infant or child drinks liquid, providing a more positive type of pressure, upon the delivery of milk, something that has just not been given consideration in the early development of the baby bottle. The standard nipple and bottle, for delivering of milk to the infant, presents a negative pressure has been built up, rather than the more desirable opposite.

The patent showing various cup assemblies, filled with liquids, and for functioning as a drinking cup, can be seen in the Manganiello, et al, U.S. Pat. No. 6,607,092, which discloses a cup assembly with a retaining mechanism.

Another patent to Manganiello, U.S. Pat. No. 6,422,415, shows a leak-proof cup assembly with flow control element.

Another patent to Manganiello, U.S. Pat. No. 6,050,445, shows a further leak-proof cup assembly with flow control element.

The patent to Morano, No. Re37,016, discloses a flow control element with covered drinking cup.

A spill-proof closure is shown in the Freeman, et al, U.S. Pat. No. 5,186,347.

The patent to Michael, U.S. Pat. No. 2,534,614, discloses the structure of a weaning cup.

The patent to Ableson, U.S. Pat. No. 2,569,139, shows a weaning cap for nursing bottles.

The patent to Tupper, U.S. Pat. No. 2,816,548, shows a sipper seal for fluidizing filled vessels.

The patent to Yeater, et al, U.S. Pat. No. 3,272,832, shows a removable cover for containers.

The patent to Albert, et al, U.S. Pat. No. 3,905,512, discloses a drinking receptacle cover and lip operated valve.

Another patent to Albert, U.S. Pat. No. 3,364,631, discloses another drinking receptacle.

The patent to Payne, et al, U.S. Pat. No. 4,138,033, shows a liquid container lid.

The patent to D'Andria, U.S. Pat. No. 4,238,045, shows a lip openable closure for containers.

The patent to Prueher, U.S. Pat. No. 4,245,752 shows a lid for drinking container.

The patent tot Tuneski, et al, U.S. Pat. No. 4,361,249, shows another beverage container lid.

The patent to Sokolowski, U.S. Pat. No. 4,441,624, shows another drinking cover.

The patent to Dart, et al, U.S. Pat. No. 4,582,214, discloses a non-spill drink-through lid.

The patent to Gartner, U.S. Pat. No. 4,756,440 also discloses an anti-spill lid for beverage container.

The patent to Nabinger, U.S. Pat. No. 4,796,774, discloses a removable and resealable lid for a container.

The patent to Johlin, et al, U.S. Pat. No. 4,921,112, shows a mug with insert for dispensing measured quantity of liquid.

The patent to Coy, et al, U.S. Pat. No. 4,946,062, shows a valved container closure.

The patent to Freeman, et al, U.S. Pat. No. 5,050,758, discloses another spill-proof closure for a beverage container.

A variety of other patents that show various types of drinking cups, whether they be for the infant, or for adults, are of the sippy cup type of category, such as can be seen in the patent to Ryan, et al, published application No. US2003/0141302, entitled drink-through lid seal. The related structure is shown in the Belcastro U.S. Pat. No. 6,786,352, showing a valve arrangement for an automatically sealing cup.

The patent to Franzese, U.S. Pat. No. 5,871,118, shows an ergonomic reusable top for beverage containers.

The patent to Garvin, U.S. Pat. No. 5,234,117, shows a straw adapter for baby bottle.

The patent to Obei, U.S. Pat. No. 4,428,498, shows a coffee cup travel lid.

The patent to McDonough, et al, in its published application No. US2004/0099674, shows an elastometric valve for a spill-proof feeding device.

The published application to Hakim, No. US2003/0098312, shows a no-spill drinking cup apparatus.

The published application to Manganiello, No. US2002/0158495, shows a leak-proof cup assembly with flow control element.

Another published application to Hakim, No. US2002/0179615, shows a no-spill drinking cup apparatus.

Another drink spout system is shown in the published application to Stillinger, et al, No. US2002/0166864.

Another cup assembly with retaining mechanism is shown in the published application to Manganiello, No. US2002/0033399.

A container cap for drinking containers having a valve body insert with a deformable sealing lip is shown in the Rohrig U.S. Pat. No. 6,758,364.

A drinking container as shown in the beverage container lid having baffle arrangement, to Milan, is disclosed in U.S. Pat. No. 6,318,584.

Nursing bottle dispensing adapter is shown in the Blum, et al, U.S. Pat. No. 6,041,951.

Another automatically sealing cup is shown in the Belcastro U.S. Pat. No. 5,890,620.

A patent to Morano, U.S. Pat. No. 5,542,670, shows a flow control element and covered drinking cup.

A nursing bottle is disclosed in the Ponder U.S. Pat. No. 3,704,803.

The patent to Rice, U.S. Pat. No. 2,680,841, shows a drinking cup for use by infants and invalids such as chair and bedridden patients.

Finally, the patent to Pettersson, U.S. Pat. No. 2,414,697, discloses an early instance of a drinking cup.

It can be determined from reviewing all of these prior patents, and these prior art types of drinking cups, nursing bottles, baby bottles, and the like, can generally be summarized as follows.

Initially, the manufacturing process for making these complex types of assemblies is both expensive and complicated. Also, in its drawing liquids from the interior of many of these feeding containers, some degree of a vacuum is formed.

The withdraw of liquid from the feeding containers is difficult for the infant, due to the fact that vacuum is generated on the interior of the container.

Furthermore, upon sucking by the infant, air bubbles are introduced into the interior of the feeding container and thus contaminate the feeding liquid.

Many of these prior art devices require multiple parts in the assembly of their drinking cups.

Multiple parts associated with these earlier drinking cups can easily be lost, misplaced, and need to be replaced, in order for the drinking cup to continue to function, which can be expensive if parts must be ordered.

In addition, the multiple parts associated with the prior drinking cups are difficult, if not impossible, to clean, increasing the risk of bacterial contamination of the feeding liquid, which may lead to gastroenteritis, and other illnesses in a child.

Furthermore, the multiplicity of parts associated with the drinking cups makes it easier for the cups to leak, especially when an infant frequently drops them, which normally happens.

When the infant is unable to feed on demand, which is the recommended method of feeding, there will always be a vacuum present in the bottle, because of previous use.

### SUMMARY OF THE INVENTION

This invention contemplates a fully and continuously vented, non-spill infant and child feeding container which comprises the feeding vessel, a vent tube extending from the superior region of the vessel down to its lower reaches, a vent reservoir that provides for venting, and prevents the entrance of feeding liquid in any amount, into the upper portion of the cup or bottle, when the cup is tilted as during usage and application.

Essentially, the bottle assembly of this invention is formed from a minimum of components, a nursing bottle, or a shortened type of nursing bottle that more resembles a cup, or a sippy cup itself, and in which the venting structure of this invention inserts, said structure in its upper regions, acts as a vent to the bottom of the bottle, so as to allow the entrance of air, into the bottle as the child is drinking, and a collar that is integral with a spout, and can clamp onto the upper end of the cup or bottle, without preventing the ingress of air into the bottle, while it is inverted, and the child is drinking. The concept of this invention also, includes its integrated spout, a spout that is formed of either a soft pliable material, or at least has that consistency at its upper reaches, where a diaphragm locates. The diaphragm is reasonably resilient, includes preferably a singular slit, although multiple slits of various configurations may be used. But when the child's mouth is applied to the spout, to drink, his/her lips place pressure upon the spout, the provided slit is opened, to allow the free flow of milk to the mouth of the drinker, while at the same time, inherently providing for venting within the interior of the bottle, so as to completely eliminate the generation of any negative pressure or a vacuum, as previously reviewed. By achieving this, the deleterious problems as previously reviewed are totally eliminated, through the usage of the structure of this invention, whether it be embodied within the nursing bottle, the sippy cup, or any other type of vessel structure, to which the venting structure and unique spout of this invention are applied.

Therefore, the principal object of this invention is to provide fully and continuously vented drinking cup for infants and children, and which eliminates the generation of any vacuum therein, during usage and application.

It is another object of this invention to provide prevention of the generation of the vacuum within an infant feeding cup automatically.

Another object is to provide an infant feeding cup which makes it easy for the infant to feed, or drink a liquid, without any adverse effects.

Still another object of this invention is to provide an infant feeding cup or bottle that eliminates the generation of air bubbles from entering into the feeding container, and thereby contaminating the feeding liquid, during consumption.

Still another object of this invention is to provide an infant feeding cup that minimizes the number of parts that are necessary to provide for the assembly of a nursing cup, and one that may function properly.

Still another object of this invention is to provide an infant feeding cup that minimizes the number of parts that are required in an assembly, thereby reducing the incidence of loss of any components.

Yet another object is to provide an infant feeding cup that utilizes parts that are easily assembled, and very easily removed.

Still another object of this invention is to provide an infant feeding cup that utilizes parts that can be very easily and thoroughly cleaned.

Yet another object of this invention is to provide an infant feeding cup that utilizes the parts that minimize the likelihood of leakage, even when the cup is dropped, which can typically happen when the infant or child is first learning how to drink from a cup of this type.

Still another object of this invention is to provide an infant feeding cup which allows the infant to feed upon demand, which is the recommended method of feeding.

Yet another object of this invention is to provide a slot in the feeding spout which will not tear and will seal itself automatically to prevent leakage.

Further objects and advantages is to provide an infant feeding cup which is economical and simple to manufacture, which is convenient and easy to use for both the caregiver and the user, and which eliminates the generation of any vacuum that occurs with other feeding cups or bottles, and which can cause unpleasant and sometimes painful sensations to the child, mainly in the ear cavities, during prolonged usage.

Furthermore, the prevention of introduction of air bubbles into the feeding liquid is an advantage that prevents the contamination of the liquid which can be aligned to the drinking of carbonated liquid, and which can cause indigestion, bloating, and stomach and gastrointestinal discomfort to the child. Other objects and advantages may become more apparent to those skilled in the art upon reviewing the summary of the invention as provided herein, and upon under taking a study of the description of the preferred embodiment, in view of the drawings.

### BRIEF DESCRIPTION OF THE DRAWINGS

In referring to the drawings, FIG. 1 is a side view of the fully and continuously vented drinking cup for infants and children;

FIG. 2 is an elevational section of the drinking cup of FIG. 1;

FIG. 3 is a perspective view of the drinking spout;

FIG. 4 is a side view of the drinking spout;

FIG. 5 is a front view of the drinking spout;

FIG. 6 is a plan view of the drinking spout and drinking cup collar;

FIG. 7 shows a slightly inclined spout for convenience to the infant during usage;

FIG. 8 is a top plan view showing the drinking spout opened during usage;

FIG. 9 is a sectional view of the drinking spout taken along the line 9-9 of FIG. 6; and

FIG. 10 is a sectional view of the drinking spout taken along the line 10-10 of FIG. 6.

### DESCRIPTION OF THE PREFERRED EMBODIMENT

In referring to the drawings, and in particular FIG. 1, the vented drinking cup 1 of this invention is readily disclosed. It includes a cup like container 2 which may be a smaller baby bottle, or a cup that is threaded at its upper opening, or any related type of container. Threadedly engaging upon the top of the cup is a collar 3, which holds the drinking spout 4 fixedly in position along the top of the structure, and through which the baby feeds, during drinking.

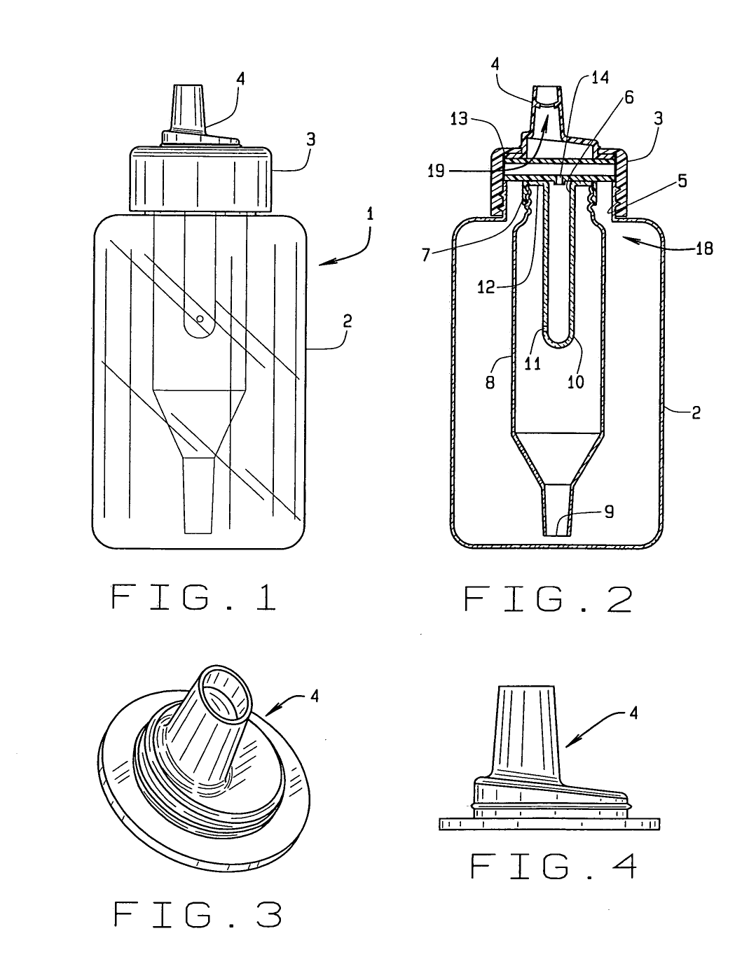

As can be seen in FIG. 2, which is a cross section of the embodiment of FIG. 1, the cup or bottle 2, has a threaded upper integral rim 5, to which the threaded collar 3 is applied. Provided for resting upon the upper edge of the rim 5 is the vent insert 6, and extending downwardly from the vent insert is a further segment or sleeve like member 7. These components can be integrally formed. Threadely engaging within the sleeve 7 is a reservoir tube 8, which has an opening provided, as at 9, at its downward most segment. Obviously, the vent insert 6, and the sleeve 7, may be formed of one piece. Furthermore, the vent insert 6, and the vent tube 10, likewise may be formed of one piece, or they may be pressured fitted together. In addition, provided within the reservoir tube 8 is the vent tube 10, and the vent tube, at its bottom end, has an aperture 11, through which air may be vented into the cup, during usage. Obviously, the reservoir tube 8 can be threadedly engaged onto the sleeve 7, or its can be press fit therein. Many of a variety of combinations of means for connection of the various elements such as the reservoir tube 8, the vent tube 9, and the vent insert 6 can be considered by one in the art. The upper end of the vent tube includes an integral flange 12 that biases against the underside of the vent insert 6, as the reservoir tube 8 is threadedly engaged or press fitted within the sleeve 7. And, as stated, the vent tube 10 can also be integrally formed with the vent insert 6, during its assembly.

The vent insert 6 has a lateral channel, as at 13, provided therethrough, and which opens into a slight gap provided between the collar 3, and the cup rim 5, so as to allow for ventilation of air to pass through the channel, through the opening 14 provided therein, down into the vent tube 10, out of it aperture 11, and down into the reservoir tube 8, for access through the opening 9, and into the cup. Thus, as the cup 2 is approximately inverted, air is allowed to enter into the cup, through the various passages and pathways as previously described, to allow venting within the cup 2, as fluid is being consumed through the spout 4, by the infant. Obviously, when the cup is inverted, there is ample space to either side of the lateral channel 13, integrally formed within the vent insert 6, which allows the milk or other fluids to flow freely from the bottle, cup or container 2, and out through the spout 4, for consumption.

Thus, the purpose of this invention as previously summarized, is to allow for a clear path for venting of the interior of the cup 2, as any fluid is being consumed, so that the child does not have to apply suction, or negative pressure, to obtain a flow of fluid through the spout 4, but that such fluids will freely flow, to attain the enhanced results for consumption of liquids by the infant or child, when using the drinking cup of this invention.

The drinking spout of this invention is also shown in FIGS. 3-10. As noted, it includes a flexible spout, as noted at 4, which may be made of rubber, resilient polymer or acrylic, but preferably of a silicone composition, to form the type of nipple as shown therein. The spout has reasonable flexibility, so when the child's mouth is applied thereon, the spout can be somewhat deformed, which to allow for that free flow of liquids out of the inverted drinking cup, during its usage and application.

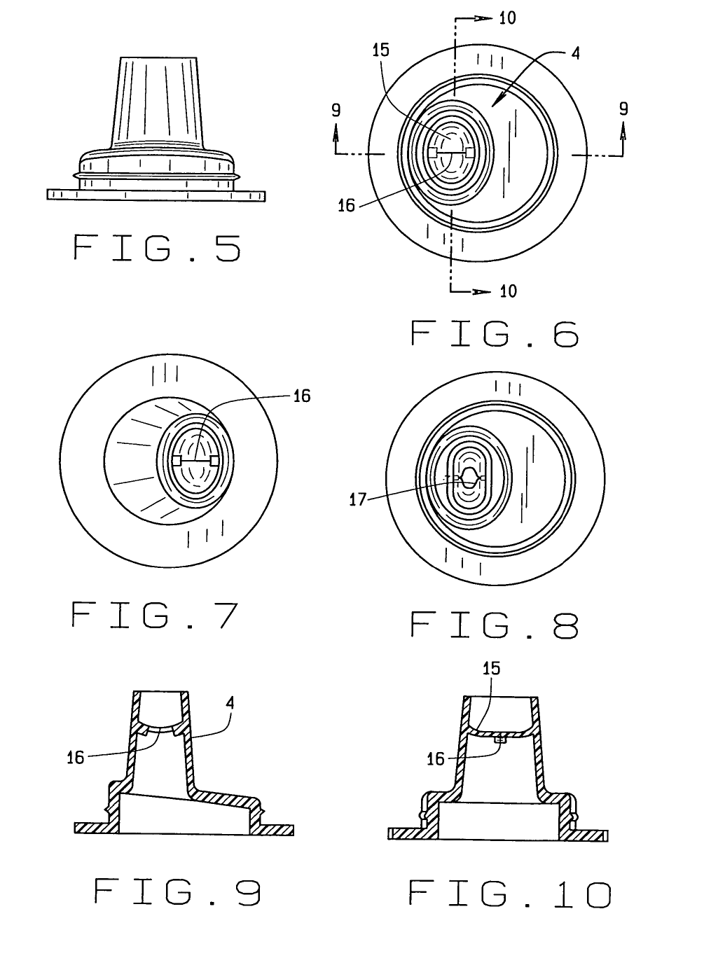

As can be seen in FIG. 6, the spout 4 generally has a depressed diaphragm 15 provided therein, which has been found convenient during usage in order to prevent any leakage of liquid from the spout, during its application, although it is just as likely that the diaphragm could be applied at the top edge of the spout, and still function reasonably well for the intended purposes of this invention. In any event, the diaphragm 15 has a perpendicular slit 16 provided there across, which under normal circumstances, the slit 16 when the drinking cup is not being applied, remains in closure, as noted in FIG. 7. Under such circumstances, normally, even if the cup should be inverted, or dropped, fluids will not be discharged from the cup, when accidentally handled, so as to prevent the discharge, or contamination of any fluids within the cup, as a result of its rough handling. Furthermore, it maintains the freshness of the fluids, due to the closure of the elastic diaphragm 15, as applied to the top of the drinking cup 2. But, when the drinking cup is being used, the slit 16 of the diaphragm is opened, as can be been at 17, as in FIG. 8, due to the lips of the infant or child depressing against the spout, to attain a flow of fluids therethrough.

FIG. 9 shows the sectional view along the slit 16 of the diaphragm 15, while FIG. 10 shows the location of the slit 16, within the diaphragm 15, when the drinking cup is not in use. It remains closed, and sealed, in order to prevent the escape of any fluids thereout, or the entrance of any foreign substance or liquid therein. It can also be seen that there are some integral tabs, or bosses, as at 20, provided to either end of the slit 16, to add reinforcement at that location, and to prevent tearing of the slit during repeat usage. Hence, it just adds a little more structural strength at the end of the slit, to prevent any tearing of the diaphragm 15, during repeat usage. As stated, the diaphragm itself may be of a more flexible material, than the spout 4 in which it is formed, the purpose being to provide for more resiliency in the material forming the diaphragm so as to allow the child's lip pressure to easily open the slit, during drinking of any fluid from the shown cup 2. As stated, this diaphragm, and the spout, may be formed of any type of flexible polymer or rubber material, or even a highly resilient acrylic, in the region of the slit, so as to add to its easy usage, during application by a child when drinking.

Obviously, the shapes of the various spouts 4, can be to any configuration, and the location of the diaphragm 15 therein, can be lower within the spout, or even at the top of the spout, or at a midpoint, generally as shown in FIG. 2. In any event, the concept of the invention is to provide a sippy cup type of resilient spout, with a slit, as at 16, that will generally be embraced by the lips of the infant or child, in a vertical direction, extending vertically between the lips, so that when the child compresses upon it, the slit will open, in the manner as shown in FIG. 8. Under these circumstances, when the drinking cup is inverted, the liquid will flow freely therefrom, just as if the child is drinking from a cup, and at the same time, the venting structure of this particular invention allows air to continuously and automatically replace the liquid that is being removed from the feeding cup or container, which allows for normal physiological feeding on demand, without the formation of any vacuum within the feeding container, which, has been found, to be harmful to the child. In other words, the primary emphasis of this invention is to eliminate the generation of any vacuum within the cup, or to avoid the child from having to suck too strenuously to get any fluid from the cup, which can cause a vacuum, not only in the cup, but within the child's physiological makeup, as mentioned, which can be harmful to the audio cavities of the child.

Furthermore, the generally T-shaped venting structure, including the transverse passage 13, and which communicates through the aperture 14 with the structured vent tube 10, of a size that generally fits within the structure of the collar 3, but yet rest upon the upper edge of the cup rim 5, as can be noted in FIG. 2. Its overall dimensions will be to that size that will allow for its locating upon the drinking cup 2, in the manner as shown, and the slight clearance provided around the threaded engagement, between the rim 5, and collar 3, allows for air to enter into the passage 13, and into the container 2, to achieve the benefits and results of this invention. Obviously, the length of the vent tube 10 or even the length of the reservoir tube 8, can vary, but generally it is desirable that its opening, as at 9, will be in close proximity, but not necessarily engaging, the bottom of the drinking cup 2, as can be seen. The relative size and proportion of the various reservoir tubes, and vent tube, should be such that accommodates the free entrance of air into the drinking cup, during its usage and application, but at the same time, not be so large as to displace liquid capacity within the drinking cup, when filed for usage.

As can obviously be seen, any of the liquid that enters into the reservoir tube 8, as the cup is inverted, will locate within the upper reaches of the reservoir tube, in the position generally at 18, thereby clearing the aperture 11 that allows for air to be vented into the reservoir tube 8, from the vent tube 10, and attain access into the cup 2, by way of the opening 9. Likewise, since the transverse passage 13, of the air passage 6, is relatively narrow of width, there is ample clearance around the vent passage 6 that allows for the free flow of liquid, from within the drinking cup, generally along what is identified as the flow line 19, to attain access for draining from the spout 4, in a manner as can be understood.

Generally, during usage of this invention, as the bottle or cup 2 is tipped from its resting position, many events occur. First, there is a small amount of liquid that is inherently contained in the air vent when the feeding container is in a resting position. As the bottle is tipped into a feeding position, the liquid that is contained inside the air vent moves into the reservoir 8. The reservoir acts as a holding chamber, as previously explained, for that liquid, and prevents it from moving into the T-shaped air venting portion 6, of the inserted bottle, and from subsequently leaking to the exterior of the feeding container. After the feeding liquid moves into the reservoir of the air vent, while the container is in the feeding position, a pathway for continuous flow of air from the exterior of the cup, through the various venting structures, and into the bottle, is achieved. Air is free to enter the feeding cup as liquid is withdrawn from the container. The amount of air that enters into the vent is proportional to the amount of liquid that is withdrawn. As the bottle is tipped back into its sitting position, the liquid that was in the reservoir moves back into the narrow interior portion of the air vent, and may escape the vent tube and pool with other feeding liquid that is maintained within the drinking cup.

As can be understood, especially from reviewing FIG. 2, this also demonstrates and shows the pathway of ventilation into the interior of the container in the feeding position and the pathway of the feeding liquid as it exits the container. When the container is inverted, the air first enters the feeding container at the juncture of the male threads of the feeding container and the female threads of the collar of the cap of the container. The air enters the T-shaped venting structure or channel 6, of the insert. The air then enters the enlarged reservoir area 8 of the venting tube, and the smaller venting tube itself, and enters the interior of the bottle or container. The air entering the container is free to enter at the rate that the infant or child is simultaneously withdrawing liquid from the feeding container, with no formation of any negative pressure or a vacuum. This is critical to the usage of the present invention.

As liquid is being withdrawn during feeding from within the drinking cup, air enters the venting tube without the need for the infant to form a vacuum on the interior of the drinking cup. With the present invention, no pathological or harmful vacuum is formed in the oral cavity of the infant's mouth, and then transferred to the eustachian tube, which can then also migrate to the middle ear of the infant, and cause damage.

The vent tube is structured in the reservoir, until the feeding container is again positioned in an upright position, for the next filling, or subsequent usage. The feeding liquid again enters the general pool of feeding liquid within the drinking cup and may exit the feeding container or reenter the vent tube in subsequent feedings. The feeding liquid in the container exits through the perimeter of the insert 6, bypasses its venting passage 6, and passes into the spout and through the diaphragm when it is opened by the mouth of the infant or child, when his/her lips put pressure upon the spout, in a manner for opening of the slit 17, as noted in FIG. 8.

In the assembly of the sippy cup of this invention, generally the structure of the container utilized is more of a cup form of container. Hence, in the preferred embodiment, it may have a length of approximately five inches, but its mouth or rim portion may be approximately two inches in diameter. This is usually much larger than the dimensions employed in a baby bottle. Hence, the ratio between the diameter of the mouth of the container, and the height of the container, may be in the range of approximately point four (0.4). Thus, the vent structure for the reservoir tube will normally locate its opening 9 at the approximate interior bottom of the container, which means that the reservoir tube itself may have a height approximating five inches, or slightly less thereof.

It is to be noted that the air enters the feeding container in a completely separate pathway from the exiting formula or liquid. This ensures that the exiting feeding liquid, and the air entering the container, so as to relieve the pressure and allow release of the feeding liquid, do not ever mix and contaminate the feeding liquid, and does not aerate the liquid, said aerating of such feeding liquid or formula is known to cause colic, irritability, and gastrointestinal medical problems.

The amount of air that enters into the feeding container is proportional to the amount of liquid that the infant or child has consumed. The infant or child can withdraw the feeding liquid from the container on demand, without encountering any negative pressure that hinders the feeding process. Feeding on demand is the same mechanism that occurs when infant's breastfeed, as there is a positive pressure in the breast, which assists the infant in feeding. That positive pressure is also generated in the inverted bottle in the present invention, during its usage.

The feeding on demand is accomplished for usage with the current invention through the incorporation of the venting mechanism which both continuously and automatically vents the interior aspects of the feeding container or drinking cup of this invention.

Thus, through usage of this invention, as structured, a number of further advantages can be attained from the structure of this development. Initially, an efficient and economical method is available to produce a spill resistant feeding container. The infant does not have to produce a vacuum in the oral cavity in order to obtain feeding of the liquid. No vacuum is transferred through the eustachian tube and the middle ear, thus minimizing the chance for fluid formation within the middle ear, and its associated developmental motor and speech delays. Vacuum in the middle ear causes a pain similar to that of flying in an airplane, without the “popping” of the ears, as many have experienced. Furthermore, the infant or child is able to feed upon demand, similar to breastfeeding. Also, the infant or child is able to avoid prolonged feeding times, minimizing exposure of the teeth to liquid and their inherent cavity forming properties. In addition, since the infant or child is able to avoid prolonged feeding times, minimizing the harmful pressure of the foreign body on the interior of the developing teeth. Also, the infant is able to transition more easily back and forth between cup feeding and breastfeeding, as a positive pressure is present in both situations, which has not been available heretofore. Likewise, there is no mixing of air and liquid, thus minimizing the air ingestion by the infant or child. This is important because air is known to contribute to gastrointestinal problems in infants and children, such as colic, irritability, fussiness, excessive gas, reflux, feeding problems, and the like. This method of feeding more closely simulates breastfeeding. Excessive air ingestion is similar to ingesting several carbonated beverages at one time. Infants with feeding problems, such as those with cerebral palsy, premature infants, and those associated with weak sucking reflex, or infants with a cleft lip and/or palate, and who cannot generate a suck reflex, and infants with other congenital or other medical problems that cannot feed well now, through usage of this invention, now have the apparatus, and the method to feed more easily and freely. Furthermore, there are fewer parts used in the drinking bottle, cup, or container of this invention, and since there are fewer parts, the entire structure is more easily cleaned. In fact, there are no parts in the feeding container that cannot be cleaned relatively easily.

Accordingly, one can see that the fully and continuously vented feeding container of this invention provides for a method of infant and child feeding which allows all caregivers to feed the infant and child in the method that is similar to breastfeeding or using the cup without a lid, which are the preferred methods of feeding, for medical and dental reasons. It further provides a method of feeding that is easy to administer and is spill resistant. Furthermore, the feeding container has the additional advantages in that it permits easy cleaning of all parts, prevents air introduction in the feeding liquid, prevents formation of a vacuum in the feeding container, it allows for feeding-on-demand, it allows for easy transition between cup and breastfeeding, and contains certain other advantages. For example, it provides for physiological feeding, as a positive pressure is present on the interior of the feeding container, the same pressure that is present with breastfeeding. It provides for physiological ear protection, as the negative pressure is not present in the oral cavity. This minimizes the complications seen with the pacifier, during its usage, and some sucking. Finally, it provides for physiological fluid ingestion, as air does not contaminate the feeding liquid prior to ingestion by the infant or child.

Although the above description contains many specifics, these should not be construed as limiting the scope of this invention, but is merely providing illustrations of some of the presently preferred embodiments of this invention. For example, the feeding container may have other shapes, such as taller, shorter, wider, narrower, and the like, and a diaphragm, insert, venting passages and other parts of the feeding container can have other shapes, or the diaphragm may be positioned differently, within the structure of the spout. The arrangement of the spout, and its integral structure, may likewise be molded to a different configuration that may more easily accommodate the drinking by the infant, during usage of the cup of this invention.

Such variations or modifications, if within the spirit of this development, are intended to be encompassed within the scope of any invention provided herein. As stated, the description of the preferred embodiment, and its disclosure in the drawings, is set forth for illustrative purposes only.

1. A drinking container adapted to be filled with a liquid, whereby a vented container prevents a vacuum from being formed within said container when inverted, the drinking container comprising:
a container having an open top and being adapted to contain a quantity of liquid;
a vent unit adapted to fit within the container and be secured at its upper edge and comprising a reservoir tube having an upper and lower portion, the reservoir tube having a proximal first end adapted to fit adjacent the top of the container and an open second end projecting sufficiently downwardly in the container so that when the bottle is inverted the open second end is above the level of the liquid in the inverted container during drinking;
an airway in the vent unit extending between the outside of the container and a point in the reservoir tube above the level of the liquid trapped in the reservoir tube when the drinking container is inverted; and
a drinking spout provided upon the container, a collar, said drinking spout held in place by said collar, to allow for liquid to flow around the vent unit and out of the spout during feeding, while allowing air to access into the container to prevent the development of any vacuum, said spout being resilient and having a diaphragm provided therein, the diaphragm having a slit which is normally closed, but upon compressing by the infant during imbibing, opens to allow for the free flow of the liquid from the inverted container.

2. The drinking container of claim 1 wherein the slit is arranged diametrically within the diaphragm as applied to the top of the feeding container during usage.

3. The drinking container of claim 2 wherein the drinking container, its container, vent unit, airway, and drinking spout, forms a sippy cup for the infant to draw liquid from the drinking container during usage.

4. The drinking container of claim 1 wherein the vent unit and its airway, as structured, forms a double venting structure.

5. The drinking container of claim 4 wherein the vent unit extends down to the approximate bottom of the drinking container, and the airway in the vent unit extends approximately one-half the way down the drinking container within the vent unit.

6. The drinking container of claim 5 wherein an opening provided within the downwardly extending airway, and wherein said opening extends laterally of the bottom of said airway.

7. The drinking container of claim 2 wherein the diaphragm approximate the slit is reinforced to prevent its tearing during prolonged usage.
